(19) United States
(12) Patent Application Publication
(10) Pub. No.: US 2009/0265582 A1
(43) Pub. Date: Oct. 22, 2009

(54) DATA PROCESSING SYSTEM AND METHOD OF DEBUGGING

(75) Inventors: Narendranath Udupa, Bangalore (IN); Nagaraju Bussa, Hyderabad (IN)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 11/814,799

(22) PCT Filed: Jan. 23, 2006
(86) PCT No.: PCT/IB06/50234

§ 371 Date: Jun. 26, 2009

(30) Foreign Application Priority Data
Jan. 25, 2005 (EP) 05100452.1

(51) Int. Cl. G06F 11/28

(52) U.S. Cl. 714/37; 714/E11.178

(57) ABSTRACT

A data processing system is provided. The data processing system comprises at least one processor (P) for processing data according to a set of instructions. The processors are coupled by a bus means (BM). Furthermore, a debugging means (DM) is provided to detect the occurrence of events and the corresponding point of time of the occurrence on the bus means (BM). If predefined events occur at, within and/or after/before predefined points in time, the debugging mode is switched on.

The present invention relates to a data processing system as well as to a method of debugging.

With modern system-on-chip (SoC) based on a multi-core architecture, the development time is greatly influenced by the time used for debugging the overall system. Therefore, an improved debugging capability of the system-on-chip will lead to a reduced development time. Also, possible bugs in the complex application will be easier to find and therefore less time consuming. Currently, in order to deal with the debugging requirement, breakpoint registers are included into the overall architecture. A breakpoint can be considered as a location in a program at which the execution thereof is stopped and the control of the executing processor is switched to a debugger. Typically the debugger stops the execution of the program depending on the type of the breakpoint. Accordingly, the execution can be stopped if a specific line has been reached, if a specific memory location is written to or read from, a specific condition is reached or the like. In hardware, these breakpoints can be embodied as breakpoint registers for data as well as instructions. These breakpoint registers can be programmed with the necessary data, address or instruction to set an appropriate breakpoint. If the program is started and is executed, the debugger serves to generate a trap when the system execution encounters the breakpoint. Thereafter, the state of the processor resources may be watched and analyzed in order to encounter the possible cause for the bug or any other significant event. In other words, the debugger will indicate an occurrence of a first order event corresponding to the programmed breakpoint, e.g. a match between the programmed data breakpoint register and the data content of a data bus or the programmed instruction breakpoint register and the actual instruction the processor is executing.

Especially in system-on-chip with a multiprocessor architecture, the detection of a first order event may not be sufficient as multi-threaded software being processed by the multi-processor architecture will include a considerable amount of interaction between the multiple processing entities. In such a scenario, it is desirable to detect complex events like an arithmetic or logical combination of a plurality of first order events. Currently, such complex events are being identified by performing the arithmetic or logical combinations of first order events externally on a trial and error basis, as the usual debugging environment does not support this feature.

US 2004/0117605 A1 discloses a digital processor with a programmable breakpoint generation circuit. The programmable breakpoint generation circuit generates triggers in response to user-defined conditions and/or sequences of trigger events. Accordingly, not only the occurrence of a first order event, but also the occurrence of a sequence of a plurality of first order events is detected. If the occurrence of events F₁ and then F₂ should fire a breakpoint, the precise time gap between the two events will not play any role in deciding to fire the breakpoint, i.e. irrespective of the time elapsed after the occurrence of F₁, the breakpoint fires as soon as F₂ occurs.

US 2004/0040013 discloses the usage of breakpoints in debuggers in order to initiate time-based breakpoints. If a breakpoint has been reached and a specified time period has elapsed, then the execution of a program is stopped. In other words, a time delay after the occurrence of a breakpoint is introduced. When a breakpoint is hit after a user-defined time delay, the debugger will take control of the execution of a program. The hitting of a breakpoint will always result in the debugger taking control of the execution of a program irrespective of any other plurality of user-defined events occurring or not occurring.

It is an object of the invention to provide data processing systems with a debugging means as well as a method for debugging which are capable of effectively detecting events and sequences of events, which are relevant for a debugging process.

This object is solved by a data processing system according to claim 1, a method for debugging according to claim 5 as well as an electronic device according to claim 6.

Therefore, a data processing system is provided. The data processing system comprises at least one processor for processing data according to a set of instructions. The processors are coupled by a bus means. Furthermore, a debugging means is provided to detect the occurrence of events and the corresponding point of time of the occurrence on the bus means. If predefined events occur at, within and/or after/before predefined points in time, the debugging mode is switched on.

Hence, while according to the prior art a breakpoint is generated if a predefined sequence of first order events occurs irrespective of any specified amount of time, a breakpoint is only generated according to the invention if the predefined events occurred within, at and/or after/before a predefined range of time. Additional time information can be included in the decision to fire a breakpoint.

According to an aspect of the invention, the debugging means comprise a plurality of registers for storing events to be detected as well as the corresponding occurrence times.

According to a further aspect of the invention the debugging means comprises a plurality of event detectors for detecting events on the bus means, and a plurality of time event units each associated to one of the plurality of event detectors for windowing the events detected by the event detector based on the pre-defined occurrence time.

The invention also relates to a method for debugging in a data processing system having a plurality of processors coupled by a bus means. The occurrence of events as well as the corresponding time of occurrence on the bus means is detected. A switching into a debugging mode is performed if pre-defined events are detected at, within and/or after/before pre-defined times of occurrence.

The invention further relates to an electronic device comprising at least one processor for processing data according to a set of instructions. The processors are coupled by a bus means. Furthermore, a debugging means is provided to detect the occurrence of events and the corresponding point of time of the occurrence on the bus means. If predefined events occur at, within and/or after/before predefined points in time, the debugging mode is switched on.

The invention is based on the idea to generate breakpoints on events or non-events and sequences of events with corresponding time information.

These and other aspects of the invention are apparent from and will elucidated with reference to the embodiments described hereinafter and with respect to the following Figures.

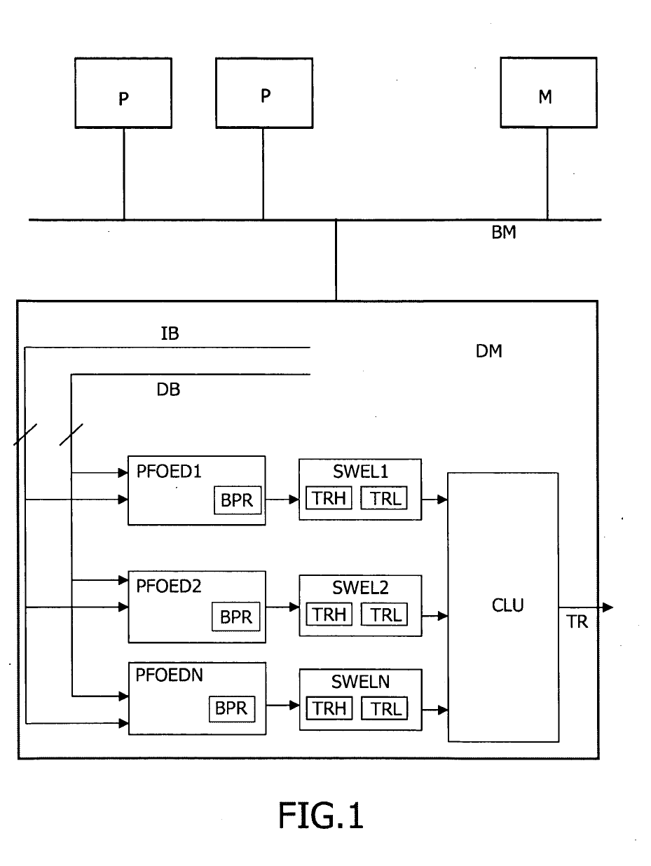

FIG. 1 shows a data processing system according to a first embodiment; and

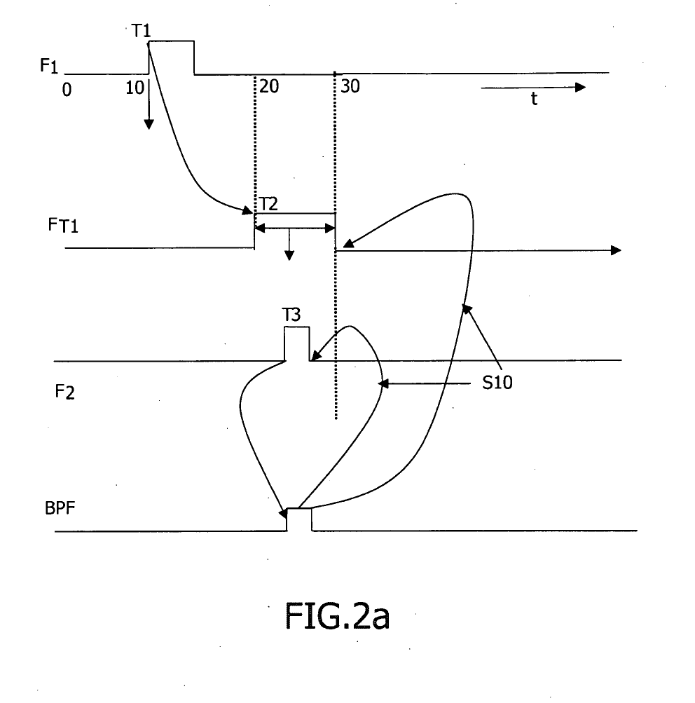

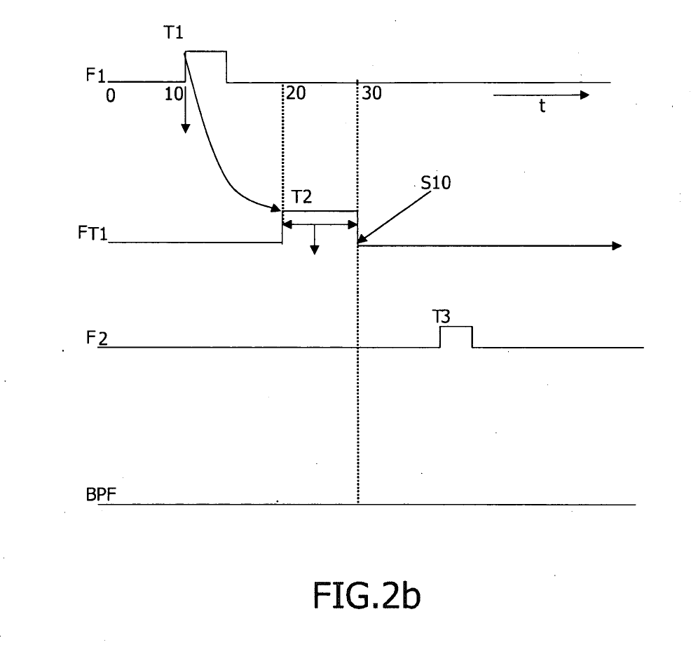

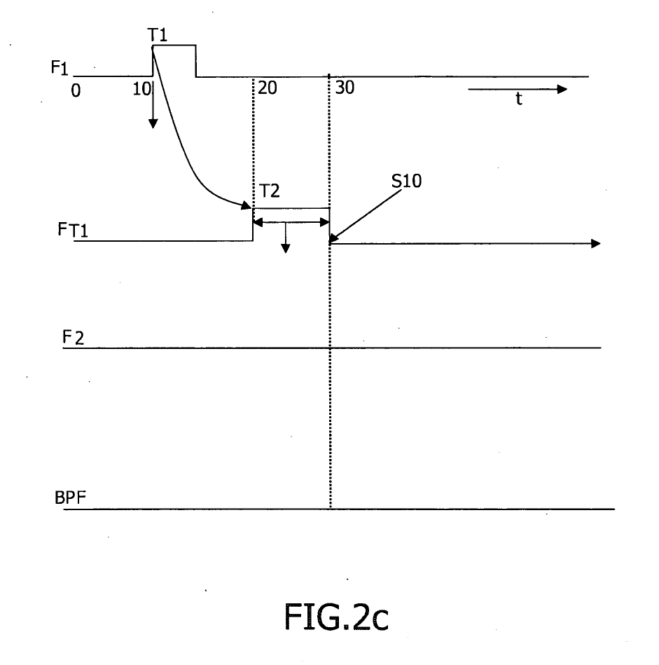

FIGS. 2a-2c show time diagrams of events occurring in a data processing system according to a first embodiment.

FIG. 1 shows a data processing system according to a first embodiment comprising a plurality of processors P or processing units, which are typically connected to a bus BM like a data bus DB and an instruction bus IB. The data processing system may also include a memory M and/or may be connected to an external memory. The data processing system may in particular be designed for media or streaming processing within a multi-core architecture.

The data processing system may comprise a plurality of processors P, a data bus DB as well as an instruction bus IB. In addition, a debugging means DM may also be present in the data processing system. The debugging means DM monitors the data bus DB and the instruction bus IB in order to detect any first order events. Whether a first order event has taken place or not, is detected by the debugging means DM by comparing the content of the programmed breakpoint registers BPR with the contents of the data and/or instruction bus. If such a first order event has taken place, the debugging means DM will not only detect the occurrence of the first order event but will also detect time information on the occurrence of the first order event. The time information is preferably related to the clock frequency of the processors. Alternatively, the time information may also be related to a reference clock or an external clock.

FIG. 1 shows a detailed block diagram of a debugging means for a data processing system according to the first embodiment. Here, the debugging means is connected to the instruction address bus IB as well as to the data address and value bus DB. The debugging means DM comprises three Programmable First Order Event Detectors PFOED1-PFOEDN. These detectors are programmed in order to capture the events F₁, F₃ and F_{N}. This can be done optionally by providing a break point register BPR in the detectors PFOED. Alternatively, the breakpoint registers BPR may also be provided elsewhere in the debugging means DM or may be mapped to the memory M. The breakpoint registers BPR are provided to store the events to be detected. The debugging means further comprises three Shifted Windowed Event Logic units SWEL1-SWELN. Each of the event logic units SWEL1-SWELN is connected to one of the event detectors PFOED1-PFOEDN. While the event detectors PFOED monitor the content of the instruction bus IB and the data bus DB, the event logic units SWEL will operate based on predefined timing information and will block the event detectors or will discard the output of the event detectors at, during or before/after the predefined time interval. Each of the shifted windowed event logic units SWEL comprises a register indicating the Time High TRH and a register for the Time Low TRL. These two registers are used to store the pre-defined time information and to define a time window.

The debugging means DM further comprises a combinational logic unit CLU which receives the outputs of the three shifted windowed event logic units SWEL and combines these outputs according to the predefined occurrences of the events and the corresponding time information stored in the registers TRH, TRL as well as according to logical combinations of the output or results of the event logic units SWEL1-SWELN. The output of the combinational logic unit CLU is then used as trigger signal TR in order to trigger the debugging mode.

FIGS. 2a-2c show a time diagram of events occurring within a data processing system according to a first embodiment of FIG. 1, respectively. In such a data processing system, a plurality of first order events like a match between the content of a programmed data breakpoint register and the content of a data bus DB and/or the instruction bus IB may be present.

In other words, time information can be associated to each of the first order events such that the occurrence of a first order event (F₁) is only relevant if the occurrence or non-occurrence of another first order event (F₂) is detected within or after/before a specific time interval. Therefore, additional time information is introduced between various events by defining a time shifted event F_{T1}. F₁ relates to a first order event 1 and F_{T1} relates to a timed first order event 1. Here, the timed first order event (F_{T1}) relates to a shifted and windowed first order event. Alternatively, a complement operation may also be used. At the end of a shifted windowed interval, the first order event detector is reset and ready to take another event. During the shifted windowed interval, the first order detector will not be able to detect any other occurrence of the specified first order event.

In FIG. 2a, the first order event F₁ and the timed first order event F_{T1} is shown. A typical logical expression defining the firing BPF of a breakpoint BP₁ is given below:

BP₁=(F₁&(10,20, F₂))

Accordingly, a first order event F₁ occurs at any time t (t=10). A time window between time t+10 to t+20 is created. If another first order event F₂ occurs within the time window (t+10 to t+20) created in previous step, a breakpoint BP₁ fires. Here, the registers TRH, TRL are set to 20 and 10, respectively.

In FIG. 2b, an alternative situation is shown. While in FIG. 2a the second first order event F₂ occurs within the time window, this second first order event F₂ occurs outside the time window (t+10 to t+20) such that the breakpoint firing BPF does not take place.

In FIG. 2c, a further situation is shown where the second first order event F₂ does not occur at all such that the breakpoint firing does riot take place.

At T1 the occurrence of the first order event F1 is detected, at T2 the shifting and windowing is performed to specify a time interval. At T3 a second first order event F₂ is detected. The events are reset after the time window (S10).

The above explanation for a second order event leading to a breakpoint firing can be extended for any higher order. For example, the fourth order event firing a breakpoint BP2 could be logically expressed as follows:

BP₂=(F₁&(20,30, F₂)&(20, 40, F₃)&(30, 35, F₄))

Accordingly, a first order event F₁ occurs at any time t. The time windows are present between time (t+20 to t+30), (t+20 to t+40), (t+30 to t+35). If first order event F₂ occurs within the time window (t+20 to t+30) AND a first order event F₃ occurs within the time window (t+20 to t+40) AND a first order event F₄ occurs within the time window (t+30 to t+35), then the second breakpoint BP₂ fires else BP₂ does not fire. Here, the registers TRH, TRL will correspond to 30, 20 for the first event logic unit SWEL1, to 40, 20 for the second event logic unit SWEL2, and to 35, 30 for the third event logic unit SWELN, respectively. The outputs of the event logic units SWEL1-SWELN are all AND combined in the combinational logic block CLB.

Another example for the fourth order event (but this time nested), the firing a breakpoint BP₃ could be logically expressed as follows.

BP₃=(F₁&(20, 30, F₂&(20, 40, F₃&(30, 35, F₄))))

Possible events for the above expression are shown below. A first order event F₁ occurs at any time t. A time window between time (t+20 to t+30) is created. If F₂ occurs within this window at time t2, then another time window (t2+20 to t2+40) is created. If F₃ occurs within this time window at t3, then another time window (t3+30 to t3+35) is created. If F₄ occurs within this time window, then the breakpoint BP₃ fires else BP₃ does not fire. Here, 4 detectors PFOED are required to detect the four events F1-F4, and at least 3 event logic units SWEL1-SWELN are required to provide the time windows between 20-30, 20-40 and 30-35.

Another logical expression could be:

BP=(F₁&(10,20, F₃&(1,5, F_{N})))

A breakpoint BP may occur if a first event F₁ occurs, a third event F₃ occurs within 10-20 cycles from the occurrence of the first event F₁ and a further event F_{N} occurs within 1-5 cycles from the occurrence of the third event F₃. Here, 3 detectors PFOED are required.

Accordingly, the register TRL of the time low and the register of the time high TRH in the first shifted windowed event logic unit SWEL will be 10 and 20, respectively. The register for the time low TRL and the register for the time high TRH of the second shifted windowed event logic unit SWEL will be 1 and 5, respectively. As no time information has been specified for the third event F_{N}, a default value (e.g. zero) is present in the two registers of the third shifted windowed event logic unit SWEL such that the third event F_{N} is neither windowed nor shifted.

Although in the above examples the output of the event logic units SWEL are AND combined in the combinational logic unit CLU, the combinational logic unit CLU may also provide other combinational logic such as NAND, OR, XOR, NOR or the like.

As a further example the debugging of a task/process such as Discrete Cosine Transform (DCT) frequently used in many media applications is considered. A debugger will need to capture a condition, where the DCT task acquired some memory blocks for reading the coefficients, processed it and then released it for writing the next set of coefficients. The existing solution will be good enough to see whether read and release happened. However, the facility to capture whether release happened within a reasonable time interval or not, is not possible with the existing solutions. If the release does not happen within a reasonable amount of time, say 50 cycles, then the timing constraint (e.g., 30 frames per sec) will not be met. However, according to the present invention, it is more important to detect whether the events read and release happened within or after/before a specified time interval than detecting whether the events read and release happened at all.

Therefore, the detection of an event happening possible due to the currently available solutions will be constrained with time information amongst the events. The debugger will define a life span for every event based on user provided time information.

The above-described principles of the invention may also be implemented by an electronic device instead of an data processing system.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim in numerating several means, several of these means can be embodied by one and the same item of hardware. The mere fact that certain measures are resided in mutually different dependent claims does not indicate that a combination of these measures cannot be used to advantage.

Furthermore, any reference signs in the claims shall not be constitute as limiting the scope of the claims.

1. Data processing system, comprising: at least one processor for processing data according to a set of instructions; a bus means for coupling the processors; and a debugging means for detecting the occurrence of events as well as their corresponding occurrence time on the bus means, and for switching into a debugging mode if pre-defined events are detected with respect to pre-defined occurrence times.

2. Data processing system according to claim 1, wherein the debugging means comprise a plurality of registers for storing events to be detected as well as the corresponding occurrence times.

3. Data processing system according to claim 2, wherein the debugging means comprises a plurality of event detectors for detecting events on the bus means, and a plurality of time event units each associated to one of the plurality of event detectors for windowing the events detected by the event detectors based on the pre-defined occurrence time.

4. Data processing system according to claim 3, wherein the debugging means further comprises a combinational logic unit for combining the outputs of the time event units.

5. Method for debugging in a data processing system having a plurality of processors coupled by a bus means, comprising the steps of: detecting the occurrence of events as well as the corresponding time of occurrence on the bus means, and switching into a debugging mode if pre-defined events are detected with respect to pre-defined times of occurrence.

6. Electronic device, comprising: at least one processor for processing data according to a set of instructions; a bus means for coupling the processors; and a debugging means for detecting the occurrence of events as well as their corresponding occurrence time on the bus means, and for switching into a debugging mode if pre-defined events are detected with respect to pre-defined occurrence times.
